(19) United States
(12) Patent Application Publication
(10) Pub. No.: US 2010/0329338 A1
(43) Pub. Date: Dec. 30, 2010

(54) LOW COMPLEXITY B TO P-SLICE TRANSCODER

(75) Inventors: Muhammed Z. Coban, San Diego, CA (US); Marta Karczewicz, San Diego, CA (US); Hongqiang Wang, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/491,894

(22) Filed: Jun. 25, 2009

(51) Int. Cl. H04N 7/26

(52) U.S. Cl. 375/240.15; 375/E07.198

(57) ABSTRACT

A system and method for transcoding compressed multimedia video is described. Particularly, a system and method for converting Bi-Predictive frame to transcoded Predictive frames, is disclosed. Present embodiments accomplish this conversion with minimal additional error, thereby providing an efficient means for maintaining video quality even after transcoding.

### BACKGROUND

1. Field of the Invention

Present embodiments relate to multimedia image processing. More particularly, these embodiments relate to a system and method for transcoding compressed data from one format to another.

2. Description of the Related Art

Digital video capabilities can be incorporated into a wide range of devices, including digital televisions, digital direct broadcast systems, wireless communication devices, personal digital assistants (PDAs), laptop computers, desktop computers, digital cameras, digital recording devices, cellular or satellite radio telephones, and the like. These and other digital video devices can provide significant improvements over conventional analog video systems in creating, modifying, transmitting, storing, recording and playing full motion video sequences.

A number of different video encoding standards have been established for communicating digital video sequences. The Moving Picture Experts Group (MPEG), for example, has developed a number of standards including MPEG-1, MPEG-2 and MPEG-4. Other encoding standards include H.261/H.263, MPEG1/2/4 and the latest H.264/AVC.

Video encoding standards achieve increased transmission rates by encoding data in a compressed fashion. Compression can reduce the overall amount of data that needs to be transmitted for effective transmission of image frames. The H.264 standards, for example, utilize graphics and video compression techniques designed to facilitate video and image transmission over a narrower bandwidth than could be achieved without the compression. In particular, the H.264 standards incorporate video encoding techniques that utilize similarities between successive image frames, referred to as temporal or interframe correlation, to provide interframe compression. The interframe compression techniques exploit data redundancy across frames by converting pixel-based representations of image frames to motion representations. In addition, the video encoding techniques may utilize similarities within image frames, referred to as spatial or intraframe correlation, in order to achieve intra-frame compression in which the spatial correlation within an image frame can be further compressed. The intraframe compression is typically based upon conventional processes for compressing still images, such as spatial prediction and discrete cosine transform (DCT) encoding.

Compression therefore transforms a collection of image frames into a collection of coded frames. MPEG uses three coded frame types: Intraframe (I) coded frames, Predictive (P) coded frames, and bi-directional (B) coded frames. Intraframe coded frames are encoded without reference to another frame and thereby permit random access. Intraframes may be used, however, as a reference for other frames. The terms “intra-frame”, “intra-coded frame” and “I frame” are all examples of video-objects formed with intra-coding that are used throughout this application. Inter or predictive coding refers to encoding a picture (a field or a frame) with reference to another picture. Compared to the Intra-coded frame, the Inter-coded or predicted frame may be coded with greater efficiency. Some examples of inter-frames that will be used throughout this application are predicted frames (either forward or backward predicted, also referred to as “P frames”), and bi-directional predicted frames (also referred to as “B frames”). Other terms for inter-coding include high-pass coding, residual coding, motion compensated interpolation and others that are well known to those of ordinary skill in the art.

Predictive coded frames are encoded using motion compensated prediction on the previous frame and may themselves be used in subsequent predictions. Bi-directional coded frames are encoded using motion compensated prediction on the previous and next frames, which may be either bidirectional or predictive frames. In most standards, H.264 being an exception, Bi-directional frames are not used in subsequent predictions.

Although H.264 and many other standards employ all three coded frame types (I,B,P-frame content), some decoders only implement predictive and intraframe pictures (I,P-Frame Content), but not bi-directional coded frames.

Bi-directional prediction, although providing improved compression over forward (unidirectional) prediction alone, requires increased computational requirements. Bi-directional predicted frames can entail extra encoding complexity because macroblock matching (the most computationally intensive encoding process) may have to be performed twice for each target macroblock, once with the past reference frame and once with the future reference frame. Introducing B frames could also increase computational complexity at the decoder side and complicate the scheduling. This increase in complexity is a major reason that the MPEG-4 Simple Profile and H.264 Baseline Profile do not support bi-directional prediction. These profiles were developed for devices requiring efficient use of battery and processing power such as mobile phones, PDAs and the like. Thus, systems and methods for transcoding streams to only I and P frames are necessary.

Unfortunately, transcoding by decompressing I,B,P-frame content back into the pixel domain and then compressing again as I,P-Frame content is inefficient. Accordingly, there is a need for a system and method which substantially preserves the frame rate and substantially maintains the quality of the content, while still transcoding I,B,P-Frame content into I,P-Frame content.

### SUMMARY OF THE INVENTION

Present embodiments include systems and methods for transcoding compressed video. In some embodiments, the system comprises a conversion module configured to convert bi-predictive frames into predictive frames and an organizing module configured to organize said predictive frames within a collection of transcoded compressed media frames. Converting may comprise replacing B macroblocks with P macroblocks of substantially similar dimensions and motion reference. In some embodiments the conversion module comprises a look-up table. The conversion module may use at least the list 0 or list 1 motion vector reference when converting a macroblock in bi-predictive mode.

In some embodiments the collection of compressed media frames comprises one or more Groups of Pictures. The conversion module may use the motion vector from the list having the greatest weight in a bi-predictive mode to convert the bi-predictive frame into a predictive frame. In some instances, the collection of transcoded compressed media frames comprises the original collection of compressed media frames that contained bi-predictive frames, having the bi-predictive frames replaced with their respective predictive frames. In other embodiments, the collection of transcoded compressed media frames comprise new compressed media frames separate from those of the original collection of compressed media frames.

A system for transcoding compressed video is also disclosed, comprising: means for bi-predictive to predictive frame conversion and means for organizing the predictive frames into a transcoded compressed video representation. The representation may comprise a Group of Pictures. The frame conversion means may comprise a look-up table. The look-up table may refer to the prediction mode of the bi-prediction frame to determine the prediction mode for the prediction frame. In some instances, the converting means comprises a collection of conversion procedures. In some embodiments, the bi-predictive to predictive frame conversion means accounts for partitioning of the bi-predictive frames into 16×16, 8×16, 16×8, or 8×8 partitions.

Some embodiments contemplate a method for encoding video, comprising: converting one or more bi-predictive frames into predictive frames; and organizing said predictive frames into a collection of transcoded compressed media frames.

Still other embodiments contemplate a computer readable medium comprising a computer readable program code adapted to be executed to perform a method comprising: converting one or more bi-predictive frames into predictive frames; and organizing the predictive frames into a collection of transcoded compressed media frames.

### BRIEF DESCRIPTION OF THE DRAWINGS

The features, objects, and advantages of the disclosed embodiments will become more apparent from the detailed description set forth below when taken in conjunction with the drawings in which like reference characters identify correspondingly throughout and wherein:

FIG. 1 is a top-level block diagram of an encoding source device and a decoding receiving device as used in certain embodiments.

FIG. 2 is a general block diagram illustrating an encoding system in which a transcoder is utilized as dictated by certain embodiments.

FIG. 3 is a schematic diagram of the effect of certain embodiments of the transcoding system described herein.

FIG. 4 is a flow diagram of the transcoding process as implemented in various embodiments.

FIG. 5 is a more detailed flow diagram of aspects of the process described in FIG. 4.

FIG. 6 is a schematic diagram of the various macroblock divisions used by the certain embodiments.

FIG. 7 is a schematic diagram of the relationship between the List 0 and List 1 reference lists used by the transcoder.

While, for the purpose of simplicity of explanation, the methodologies shown in the various Figures are shown and described as a series of acts, it is to be understood and appreciated that the present invention is not limited by the order of acts, as some acts may, in accordance with the present invention, occur in different orders and/or concurrently with other acts from that shown and described herein.

### DETAILED DESCRIPTION

Present embodiments include a low complexity system and method for transcoding video content so that it is compatible with multiple video decoders. In one embodiment, the system and method relates to removing Bi-directional (B) type coded frames from video content. Thus, the system may transcode videos that have I, B, and P-type frames, complying with the H.264 (AVC) video standard, into video content that only has I and P-type coded frame content. The system and method relate to mapping the B-type coded frames into P-type coded frames by utilization of the existing B (sub)macroblock prediction motion vector information. This approach provides a very low complexity transcoding solution in terms of memory usage/bandwidth. In addition, in this embodiment there is a low computational complexity while retaining a relatively high video quality. These embodiments are therefore suitable for any devices requiring an efficient means for quick conversion.

The system described herein utilizes motion vectors, macroblock modes and image residual information from the original content during the transcoding process in order to achieve a low complexity implementation with little or no degradation in video quality. In some embodiments the I and P-frames existing in the original video bitstream are preserved (re-used without any transcoding). In these embodiments, only the B-coded frames in the original bitstream are transcoded into P-coded frames. In one embodiment, the original encoding order of the frames in the video bitstream and the reference types of the frames may be preserved.

For the sake of clarity, certain of the embodiments will be described below generally giving an account of the transcoding at the image frame level. However, in practice, the transcoding operation may also take place at the block and macroblock level, as well, using the same procedures mutatis mutandis.

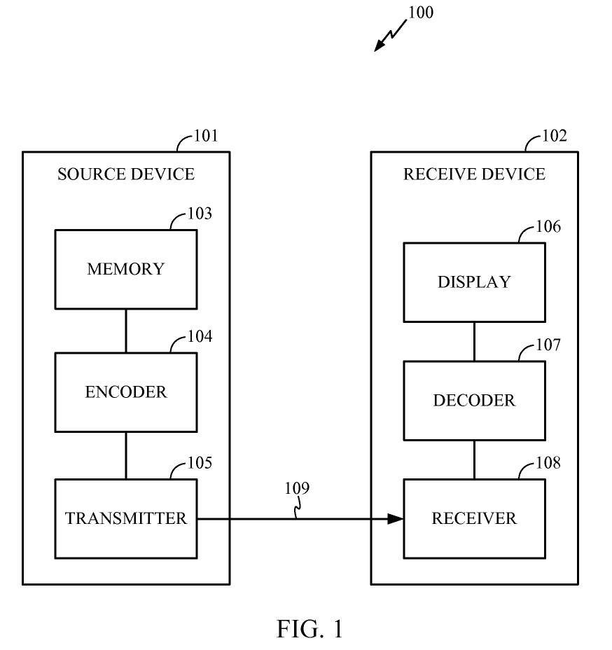

FIG. 1 is a block diagram illustrating an example media encoding/decoding system 100 in which a source device 101 transmits an encoded sequence of video data over communication link 109 to a receive device 102. Source device 101 and receive device 102 may both be digital video devices. In particular, source device 101 encodes and transmits video data using any one of a variety of video compression standards. Communication link 109 may comprise a wireless link, a physical transmission line, a packet based network such as a local area network, wide-area network, or global network such as the Internet, a public switched telephone network (PSTN), or combinations of various links and networks. In other words, communication link 109 represents any suitable communication medium, or possibly a collection of different networks and links, for transmitting video data from source device 101 to receive device 102.

Source device 101 may be any digital video device capable of encoding and transmitting video data. For example, source device 101 may include memory 103 for storing digital video sequences, video encoder 104 for encoding the sequences, and transmitter 105 for transmitting the encoded sequences over communication link 109. Memory 103 may comprise computer memory such as dynamic memory or storage on a hard disk. Receive device 102 may be any digital video device capable of receiving and decoding video data. For example, receive device 102 may include a receiver 108 for receiving encoded digital video sequences, decoder 107 for decoding the sequences, and display 106 for displaying the decoded sequences to a user.

Example devices for source device 101 and receive device 102 include servers located on a computer network, workstations or other desktop computing devices, and mobile computing devices such as laptop computers. Other examples include digital television broadcasting systems and receiving devices such as cellular telephones, digital televisions, digital cameras, digital video cameras or other digital recording devices, digital video telephones such as cellular radiotelephones and satellite radio telephones having video capabilities, other wireless video devices, and the like. Further examples of receive devices 102 include desktop computers, laptop computers, personal digital assistants (PDAs), smart phones, iPods, MP3 players, handheld gaming units or other media players, and a wide variety of other consumer devices.

Source device 101 includes an encoder 104 that operates on blocks of pixels within the sequence of video images in order to encode the video data into a compressed format. For example, the encoder 104 of source device 101 may divide a video image frame to be transmitted into a number of smaller image blocks (known as “macroblocks”). For each macroblock in the image frame, encoder 104 of source device 101 searches macroblocks stored in memory 103 for the preceding video frame already encoded (or a subsequent video frame yet to be encoded) to identify a similar macroblock, and encodes the difference between the macroblocks, along with a motion vector that identifies the macroblock from the previous frame that was used for encoding. This encoding is part of the standard compression procedure, and the compressed macroblocks may be part of I,B, or P frames.

The receiver 108 of receive device 102 receives each of the frames and their accompanying macroblocks. For each macroblock's motion vector and encoded video data decoder 107 performs motion compensation techniques to recover the original video sequence. This sequence may then be displayed via display 106. One skilled in the art will readily recognize that rather than display the decoded data various other actions may be taken including storing the data, reformatting the data, or retransmitting the decoded data. The decoder 107 of receive device 102 may also be implemented as an encoder/decoder (CODEC). In that case, both source device and receive device may be capable of encoding, transmitting, receiving and decoding digital video sequences.

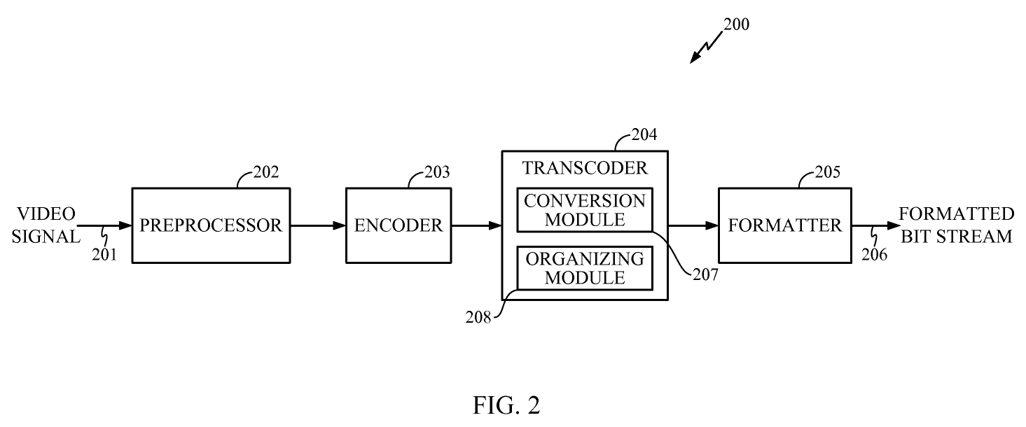

FIG. 2 is a general block diagram illustrating embodiments of the transcoding operation in relation to the system of FIG. 1. In some embodiments, receive device 102 may only receive I and P frame data—i.e. transcoded data. In these embodiments, transcoding operation 200 may take place at encoder 104 or at decoder 107 of FIG. 1 or anywhere therebetween. A video signal 201 arrives in a preprocessor 202 which may serve a variety of purposes, or may be excluded from the system altogether. Preprocessor 202 may, for example, format the video signal into components that are more easily processed by the compression or transcoding system. After preprocessing, the video signal is sent to an encoder 203 which encodes the video signal for transmission to a decoder. Following video encoding, the video signal is sent to transcoder 204 which transcodes the signal as described herein to remove B-type coded frames so that the resulting video content is compatible with a wider range of decoders. Transcoder 204 accomplishes these operations with the aid of conversion module 207 and organizing module 208. After transcoding, the video signal is sent to a formatter 205 which may quantize the transcoded video signal. Reformatting may comprise quantization which is discussed in more detail infra. The formatter may be found anywhere between the encoder 104 and decoder 107. The transcoded stream is then reformatted at the reformatter 205 and emerges as a formatted video stream 206.

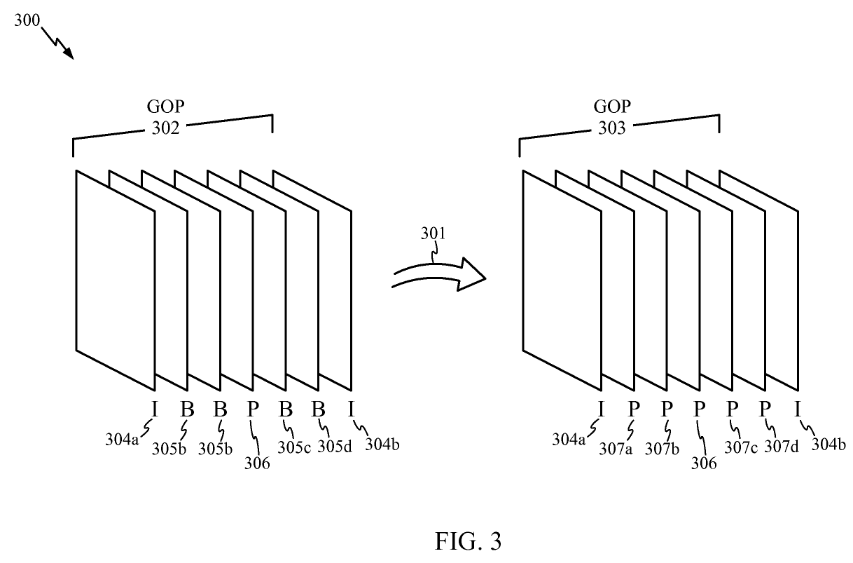

As mentioned previously, the encoded media that is typically transcoded comprises a sequence of I, B and P coded frames. FIG. 3 shows a sequence of encoded media frames known as a group-of-picture frames (GOP) 302. An encoded video stream comprises a succession of GOPs. The GOP 302 begins with an I coded frame 304a and thereafter comprises a sequence of one or more B 305(a,b,c,d) and one or more P frames 306 and stopping before the I-frame 304b of the next GOP. The initial I frame 304a represents a full image frame. B and P frames may refer to I frames in their compressed data representations. In H.264 B frames can be referenced by other frames in order to increase compression efficiency.

Present embodiments transcode 301, via a conversion module 207, the collection of frames 302 comprising B frames into the collection of frames 303 comprising only I and P frames. Although shown here as a group of frames, transcoding 301 may take place among a subset sequence of frames or upon a larger collection of portions of GOPs. In some embodiments the P frames 306 are untouched, while the original B frames 305(a-d) are replaced with transcoded P frames 307(a-d). In these embodiments the I and P-frames existing in the original I,B,P frame bitstream may simply be carried over to the transcoded bitstream. The original encoding order of the frames and the reference types of the frames that they belong to in the bitstream may be preserved. Some embodiments however, contemplate additionally reordering or replacing the frames to accomplish efficiency gains.

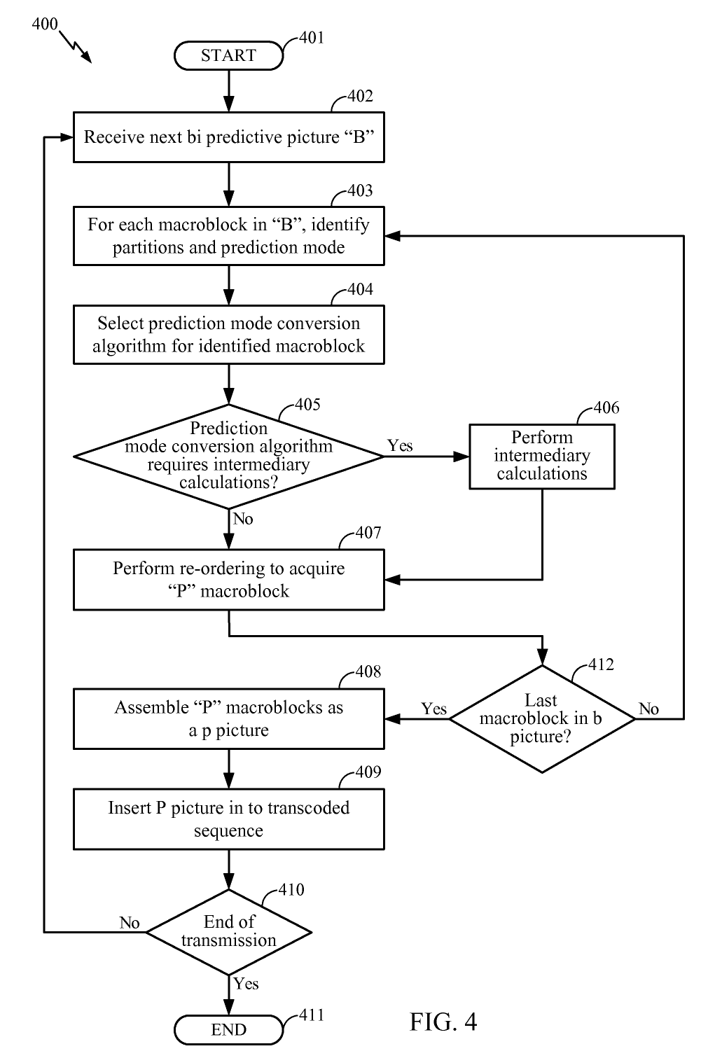

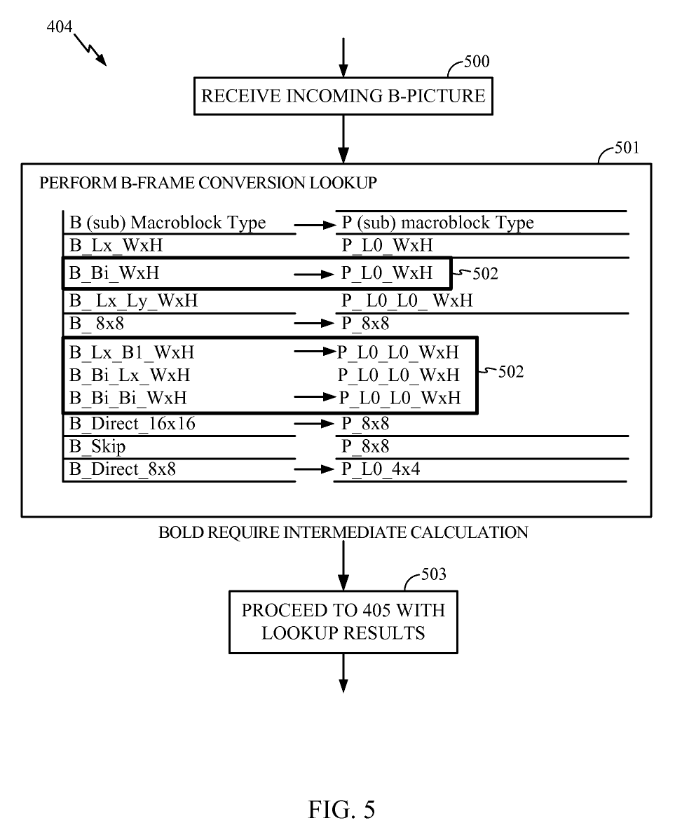

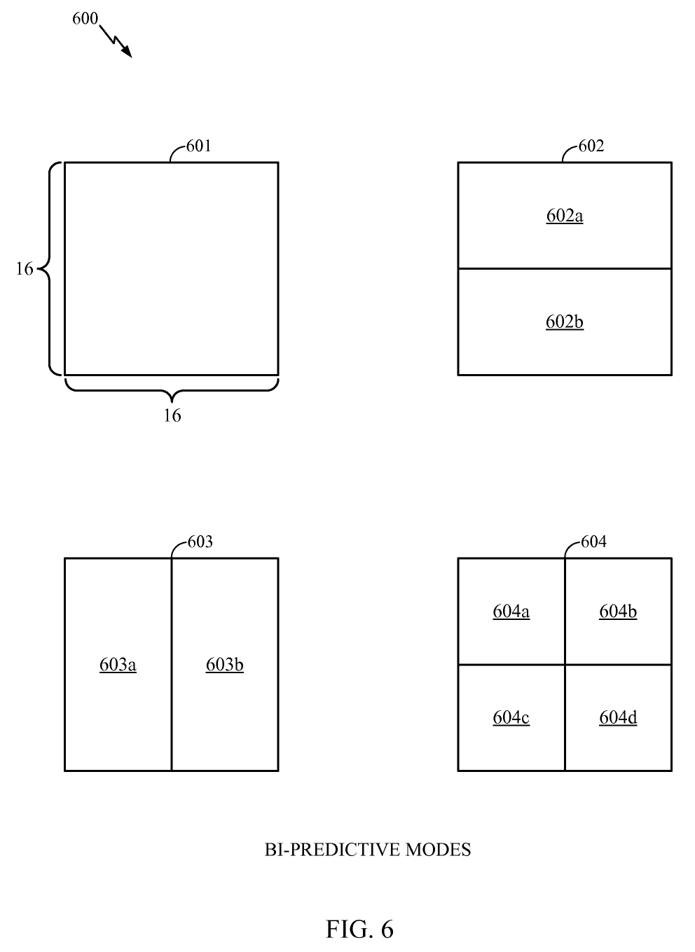

FIG. 4 is a flow diagram of the transcoding process 400 as implemented in the conversion modules 207 of the various embodiments. The transcoding process begins 401 by receiving the next B frame 402 to be processed. The process iterates over the macroblocks 403 and the submacroblocks in turn of the B frame, identifying the partitions and prediction modes of each. This step will be described in more detail with reference to FIGS. 5 and 6. For each of these macroblocks, the proper prediction frame conversion algorithm or conversion procedure is identified 404. If this algorithm requires intermediate calculations 405 they are performed 406 before creating a transcoded “P” macroblock 407. If this was not the last macroblock or sub macroblock of the B-frame then the process repeats for the subsequent (sub) macroblock 412. If this is the last macroblock, then the transcoded P macroblocks are assembled together into a new transcoded P frame 408 and inserted into the transcoded sequence 409, typically via an organizing module 208. The organizing module may perform a modest function—i.e. simply replace B-frames with transcoded P-frames in the pre-existing sequence. Alternatively, the organizing module may insert the transcoded P-frames into an entirely new sequence, based upon the original sequence or having an entirely novel origin. If this was the last B frame to be handled by the transcoder 410, the process ends 411, otherwise the process begins again with the next B frame 402.

The step of identifying partitions and prediction mode 403 for each macroblock in the B-frame to be transcoded will now be described in greater detail with reference to FIGS. 5 and 6. FIG. 5 provides a more detailed view of the partition and prediction mode identification 404. After a B frame is received 500 and its macroblocks identified, certain of the present embodiments then perform a B-frame conversion lookup 501. The lookup depends on the nature of the macroblock and how its partitions are divided.

FIG. 6 illustrates various partitions of a bi-prediction mode macroblock of width 16 pixels by 16 pixels. As shown in 601, the macroblock may not be divided at all. The macroblock may be divided horizontally 602, vertically 603, or in quarters 604. The height and width of the subpartitions 602, 603(a-b) need not be evenly divided and may for example take dimensions of 8×16, 8×8, 16×8, etc. Each of these sub-blocks may in turn be divided as determined by the original compression scheme.

Returning now to FIG. 5, the conversion table is organized by the B (sub)macroblock type. Each inter-frame macroblock may typically comprise one of four prediction types: List 0, List 1, direct prediction (also known as B_Skip), or Bi-predictive. Additional modes, such as intramode, are available depending on the standard. Each partition of FIG. 6, i.e. the 8×16, or 8×8 sub-partitions, may have its own prediction mode. Thus, as shown in FIG. 5, a B-frame having a (sub) macroblock with dimensions W×H that is in List 0 mode (B_B_W×H), would be referred to as B_L_{0—}W×H. The conversion would transform this mode of (sub)macroblock to a P-frame (sub)macroblock of identical dimensions and mode P_L_{0—}W×H. Other (sub)macroblocks are represented in a similar manner.

As shown in FIG. 5, many of the conversions require no intermediate calculation and may proceed directly to a P frame (B_L_{x—}W×H, B_L_{x—}L_{y—}W×H, B_{—}8×8, etc.). In these cases, the contents of the B macroblock reference a single point in the reference lists for each of the one or more sub blocks. Accordingly, the transcoded P-frame may contain little or no error in comparison with the original B-frame. However, when a portion of the motion block includes a bi-predictive element, (i.e. B_Bi_W×H, B_Lx_Bi_W×H, etc.) 502 additional computation may be necessary.

As mentioned previously, certain of the embodiments have been described at the image frame level. However, in practice, the computations described below may also take place at the block and macroblock level, as well, using the same procedures mutatis mutandis.

### Modes Transcoded Without Additional Computation

List 0, List 1

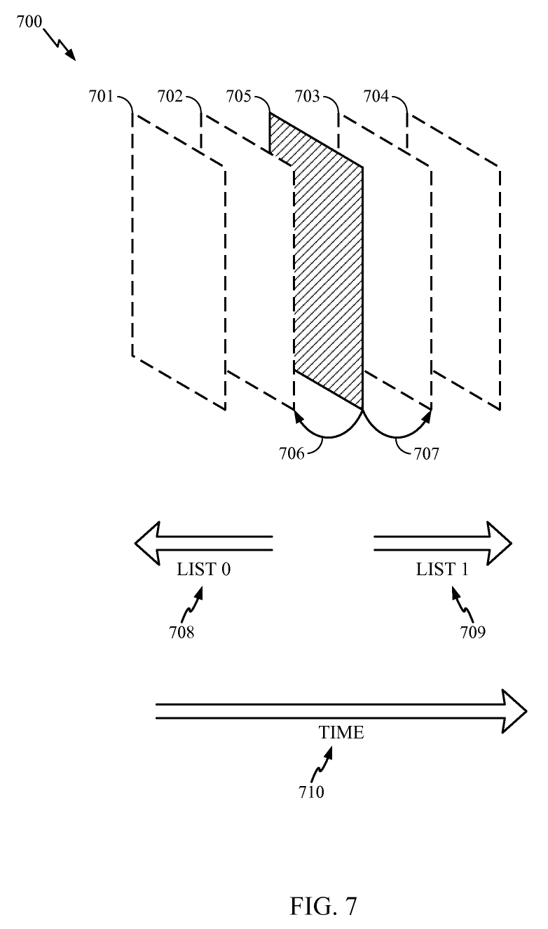

List 0 and List 1 are reference lists to frames preceding or succeeding the present frame. As shown in FIG. 7, List 0 708 is a reference buffer list of previous frames 701, 702 from the frame containing the presently considered macroblock 705. List 1 in contrast, is a reference list to future upcoming frames 703, 704. In many implementations the lists may circle back upon one another. That is, after listing several past frames, List 0 may then list several future frames within a range. List 1, may similarly list several future and then several past frames in a range. Accordingly, FIG. 5 illustrates both List 0 and List 1 B-Frame (sub)macroblocks being transcoded to List 0 blocks, since the List 1 references may be recovered by appropriately changing the index in the P-frame's List 0 reference. In each of the List 1 and List 0 reference lists, the first references are the temporally closest to the present frame. In some embodiments, however, the ordering of List 1 and List 0 will be dependent on an output order, or picture order count (POC) value, of previously referenced frames. In some instances, the first referenced frame of the list may be confined to a particular type—such as a P frame. A macroblock portion in either List 0 or List 1 mode references only the single list. Accordingly, the transcoded P-frame portion may have no transcoding generated error, since it is possible to encode the exact same reference to either List 0 or List 1 in a P-frame.

Direct Prediction

Direct prediction is inferred from previously transmitted syntax, which may be either List 0, 1, or bi-prediction. In the direct mode, two motion vectors of both directions are derived from a single motion vector. This motion vector is itself derived from a co-located block in a neighboring frame. Accordingly, as with the List 0 and List 1 type frames, a transcoded P-frame may reflect the contents of a direct-mode B-frame without substantial error.

### Bi-Predictive Modes Requiring Additional Computation to Transcode

Bi-predictive inter-prediction, unlike either List 0, List 1, or direct prediction, takes the weighted average of two other frames, from either List 0, List 1, or both. For bi-predictive (two motion vectors) modes, the prediction blocks used in B-macroblocks may be represented by:

B=(w₀·P₀+w₁·P₁)/2 (1)

where P_{0,1} represent the first and second referenced frames respectively. As mentioned these may be both found in List 0, List 1, or one in each. The weights w_{0,1} represent the degree by which each frame is considered. Together, the weights add to two. Thus, if only the second frame, P₁ were to be considered, w₁ would equal two and w₀ would equal zero. Similarly if both frames were to be equally considered both weights would equal one (one skilled in the art will readily recognize numerous similar weighting schemes, the present description is but one exemplary embodiment).

A transcoded P-frame typically cannot refer to two separate frames. Accordingly, present embodiments consider a variety of methods for reducing the error that arises when a fully bi-predictive frame is transcoded into a P-frame having only a single reference. In one embodiment, when a Bi-predictive B-frame is transcoded into a P-frame, P′, only one of the two weights and references is used.

P′=w_{0,1}·P_{0,1} (2)

This is generally represented by the entries in FIG. 5 replacing Bᵢ with L₀.

As mentioned, an error may result between the original Bi-predictive value and the new transcoded P-frame when only a single reference is used. This error may be represented as the difference between the original B frame and the transcoded P frame:

B−P′=(w₀·P₀+w₁·P₁)/2−w_{0,1}·P_{0,1} (3)

B−P′ therefore equals either

(w₁·P₁−w₀·P₀)/2 (4)

or

(w₀·P₀−w₁·P₁)/2 (5)

depending on whether the first or second references respectively are chosen.

In some embodiments, to minimize the error between the bi-predictive and transcoded modes, various modifications may be made. In one embodiment, only the references having larger weights are used for the transcoding. That is, if w₀>w₁ then the P₀ reference motion vector may be used. In even further embodiments, even if a single reference from the bi-predictive frame is used, the weight may be appropriately modified to reflect a value more approximate to the original bi-predictive references.

The techniques described in this disclosure may be implemented in hardware, software, firmware, or any combination thereof. Any features described as units or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software units or hardware units configured for encoding and decoding, or incorporated in a combined video encoder-decoder (CODEC). Depiction of different features as units is intended to highlight different functional aspects of the devices illustrated and does not necessarily imply that such units must be realized by separate hardware or software components. Rather, functionality associated with one or more units may be integrated within common or separate hardware or software components.

Although the present invention has been fully described in connection with MPEG-x and H.26x type compression schemes, it is clear that other video compression schemes can implement the methods of the present invention.

Various embodiments of this disclosure have been described. These and other embodiments are within the scope of the following claims.

We claim:

1. A system for transcoding compressed video, comprising:
a conversion module configured to convert bi-predictive frames into predictive frames;
an organizing module configured to organize said predictive frames within a collection of transcoded compressed media frames.

2. The system of claim 1, wherein converting comprises replacing B macroblocks with P macroblocks of substantially similar dimensions and motion reference.

3. The system of claim 1, wherein the conversion module comprises a look-up table.

4. The system of claim 1, wherein the conversion module uses at least a list 0 or list 1 motion vector reference when converting a macroblock in bi-predictive mode.

5. The system of claim 1, wherein the collection of compressed media frames comprises one or more Groups of Pictures.

6. The system of claim 1, wherein the conversion module uses a motion vector from a list having the greatest weight in a bi-predictive mode to convert the bi-predictive frame into a predictive frame.

7. The system of claim 1, wherein the collection of transcoded compressed media frames comprises an original collection of compressed media frames that contained bi-predictive frames, but having the bi-predictive frames replaced with their respective predictive frames.

8. The system of claim 1, wherein the collection of transcoded compressed media frames comprise new compressed media frames separate from those of an original collection of compressed media frames.

9. A system for transcoding compressed video, comprising:
means for bi-predictive to predictive frame conversion,
means for organizing the predictive frames into a transcoded compressed video representation.

10. The system of claim 9, wherein the representation comprises a Group of Pictures.

11. The system of claim 9, wherein the frame conversion means comprises a look-up table.

12. The system of claim 11, wherein the look-up table refers to a prediction mode of the bi-prediction frame to determine the prediction mode for the prediction frame.

13. The system of claim 9, wherein the converting means comprises a collection of conversion procedures.

14. The system of claim 9, wherein the bi-predictive to predictive frame conversion means accounts for partitioning of the bi-predictive frames into 16×16, 8×16, 16×8, or 8×8 partitions.

15. A method for encoding video, comprising:
converting one or more bi-predictive frames into predictive frames; and
organizing said predictive frames into a collection of transcoded compressed media frames.

16. The method of claim 15, wherein the step of converting one or more bi-predictive frames into predictive frames comprises replacing B macroblocks with P macroblocks of substantially similar dimensions and motion reference.

17. The method of claim 15, wherein the step of converting one or more bi-predictive frames into predictive frames uses at least a list 0 or list 1 motion vector reference when converting a macroblock in bi-predictive mode.

18. The method of claim 15, wherein the collection of compressed media frames comprises one or more Groups of Pictures.

19. The method of claim 15, wherein the collection of compressed media frames comprises an original collection of compressed media frames that contained bi-predictive frames, but having the bi-predictive frames replaced with their respective predictive frames.

20. The method of claim 15, wherein the collection of compressed media frames comprises new compressed media frames separate from those frames of an original collection of compressed media frames.

21. A computer readable medium comprising a computer readable program code adapted to be executed to perform a method comprising:
converting one or more bi-predictive frames into predictive frames; and
organizing the predictive frames into a collection of transcoded compressed media frames.
